(19) United States
(12) Patent Application Publication
(10) Pub. No.: US 2010/0061637 A1
(43) Pub. Date: Mar. 11, 2010

(54) IMAGE PROCESSING METHOD, IMAGE PROCESSING APPARATUS, PROGRAM AND IMAGE PROCESSING SYSTEM

(76) Inventors: Daisuke Mochizuki, Chiba (JP); Akiko Terayama, Tokyo (JP); Takuro Noda, Tokyo (JP); Takuo Ikeda, Tokyo (JP); Eijiro Mori, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/550,455

(22) Filed: Aug. 31, 2009

(30) Foreign Application Priority Data
Sep. 5, 2008 (JP) P2008-227881

(51) Int. Cl. G06K 9/46

(52) U.S. Cl. 382/199; 382/201

(57) ABSTRACT

An image processing apparatus includes a binarization unit that binarizes a selected image region based on prescribed criteria into an image trimming target white pixel region and a background black pixel region, a hole filling unit that fills a hole of the white pixel region by converting a black pixel surrounded by the white pixel region into the white pixel, a distance conversion unit that calculates a distance value from each white pixel to the black pixel region, a skeleton extraction unit that extracts points indicating a skeleton of the white pixel region according to each distance value, and a trimming outline determination unit that excludes a less significant point based on prescribed conditions, draws an oval or perfect circle according to each distance value, centered at a non-excluded point, and determines an outer edge of ovals or perfect circles as an outline for trimming a trimming target image.

### BACKGROUND OF THE INVENTION

1. Field of the Invention

The present invention relates to an image processing method, an image processing apparatus, a program and an image processing system that shape the outline of an image into a geometric shape, and, particularly, to image processing that shapes an image into a circular or polygonal shape.

2. Description of the Related Art

Image information is typically represented by rectangular two-dimensional data for convenience of camera operation. For example, an image placed on an auction site is represented in a shape such that an item can be enclosed within a rectangular frame. Therefore, the image is represented in a display device also by the same rectangular shape or a quadrangular shape after affine transformation or projective transformation. Further, in applications such as photograph display on a photograph viewing browser, thumbnail display and a scrapbook viewable on a computer, an image is generally represented by a quadrangular shape. However, although data is turned out to be stored as image information in a rectangular shape, an eye-catching object in the stored image originally has an indefinite shape, not the rectangular shape, in most cases. Therefore, if it is necessary to handle images always in a quadrangular shape, flexibility in design is low, failing to offer fun.

As a method of representing an image in a shape different from the rectangular shape, a technique is known that prepares a trimmed shape of an image in advance and puts a given image into the shape, for example. In this method, however, because it is not taken into consideration what is contained in what shape in the image to be put at the time of preparing the trimmed image, it is difficult to perform trimming in consideration of the feature part of the image.

On the other hand, various kinds of techniques are proposed that extract or select a part of a region in an image according to the content of the image in consideration of the feature part of the image. One is a method called binarization that leaves only a color contained in a certain color range in an image. This is one of the simplest methods for selecting a region. Further, a technique called visual attention is also proposed that selects a region which is likely to attract visual attention from an image based on the human recognition mechanism (cf. e.g. Japanese Unexamined Patent Publication No. 2008-53775).

### SUMMARY OF THE INVENTION

However, the technique of extracting a part of the image according to the content of the image considers nothing about the shape of the outline region of the extracted image. Therefore, even if the extracted region is favorable for computer processing, it often has a less attractive shape as a region to be represented by trimming the image and is thus not appropriate for visually appealing image representation.

Also proposed are a method called region segmentation that divides an object in an image into a plurality of regions in significant units, and a technique that recognizes an actual object in an image and selects an actual region where the object exists. In such method and technique, although the region is selected appropriately for the shape of the object if correct recognition is done, the object is not always recognized correctly according to normal human recognition in automatic processing by computers. Further, even if the object is recognized correctly, mechanical recognition of the object is so specific that the selected region can be a rather unattractive looking shape in some cases.

In light of the foregoing, it is desirable to propose image processing that shapes a prescribed image region into a desired geometric outline.

According to an embodiment of the present invention, there is provided an image processing method including the steps of performing distance conversion that calculates a distance value from a first pixel region on a trimming target side to a second pixel region on a background side of a binarized image, performing skeleton extraction that extracts a plurality of points indicating a skeleton of the first pixel region according to the distance value of each first pixel, and performing trimming outline determination that excludes a point, out of the plurality of extracted points, judged to be less significant based on prescribed conditions, draws an oval or a perfect circle according to the distance value of a pixel of each point, centered at a position of a non-excluded point, and determines an outer edge of a plurality of drawn ovals or perfect circles as an outline for trimming an image on the trimming target side.

In this configuration, while a point that is included in the plurality of points indicating the skeleton of the first pixel region and judged to be less significant based on prescribed conditions is excluded, an oval or a perfect circle according to the distance value of a pixel of each point is drawn centered at a position of a non-excluded point. The outer edge of a plurality of drawn ovals or perfect circles is determined as the outline for trimming an image on the trimming target side. It is thereby possible to shape an attention-getting image into the region shape formed by a plurality of circles.

In the determination of the outline, a point indicating a skeleton that is judged to be less significant based on prescribed conditions is excluded. Accordingly, a set of arc shapes centered at a highly significant point can be set as the outline when trimming the image. It is thereby possible to trim the image on the trimming target side into a visually pleasing arc shape.

The image processing method may further include the steps of performing binarization by binarizing an image region selected from an original image based on prescribed criteria into the first pixel region on the image trimming target side and the second pixel region on the background side, and performing hole filling by filling a hole of the first pixel region by converting a second pixel surrounded by the first pixel region into a value of the first pixel.

As an example of prescribed conditions for excluding a less significant point out of a plurality of points indicating the skeleton of the first pixel region, the step of performing trimming outline determination may exclude a point, out of the plurality of extracted points, located inside an oval or a perfect circle already drawn, judging the point to be less significant.

The step of performing trimming outline determination may exclude a point, out of the plurality of extracted points, where the distance value of a pixel of each point is equal to or smaller than a given threshold, judging the point to be less significant.

The step of performing trimming outline determination may draw an oval or a perfect circle according to the distance value of a pixel of each point in a sequence of points, out of the plurality of extracted points, detected by scanning a selected image region sequentially from an upper left.

The step of performing trimming outline determination may draw a prescribed number of ovals or perfect circles according to the distance value in a sequence of points of pixels having a larger distance value, out of the plurality of extracted points.

The step of performing trimming outline determination may end if the number of ovals or perfect circles centered at a position of the point becomes larger than a prescribed number.

According to another embodiment of the present invention, there is provided an image processing method including the steps of performing maximum image extraction that extracts a maximum region in the first pixel region on the trimming target side of the binarized image, performing outline point extraction that extracts a plurality of outline points of the extracted maximum region in the first pixel region, and performing trimming outline determination that excludes an outline point, out of the plurality of extracted points, judged to be less significant based on prescribed conditions, and determines a polygon connecting adjacent points of non-excluded outline points as an outline for trimming an image on the trimming target side.

In this configuration, while a point that is included in the plurality of outline points indicating the outline of the first pixel region and judged to be less significant based on prescribed conditions is excluded, a polygon connecting adjacent points of non-excluded outline points is determined as the outline for trimming the image on the target side. Because the less significant outline points are excluded, the trimming outline can be shaped into the polygonal region shape having only the significant outline points as the apexes. This enables shaping of the outline in the feeling that a person cuts out the image freely with scissors, for example, despite of being computer processing. It is thereby possible to trim the image on the trimming target side into a visually pleasing shape.

The step of performing trimming outline determination may detect a polygon where an area of a polygon formed by three or more adjacent outline points, out of the plurality of extracted points, is smallest, and excludes an outline point located in middle of three or more outline points forming the detected polygon, judging the outline point to be less significant.

The step of performing trimming outline determination may assign different weights to an area of a triangle formed by three or more adjacent outline points, out of the plurality of extracted points, depending on whether the triangle forms either one of a protrusion or a hollow of a polygon connecting adjacent points of the plurality of outline points, detect a triangle where an area after assigning weights is smallest, and exclude an outline point located in middle of three outline points forming the detected triangle, judging the outline point to be less significant.

The step of performing trimming outline determination may end if the number of outline points becomes equal to or smaller than a prescribed number as a result of repeating excluding an outline point judged to be less significant.

The image processing method may further include the step of performing thinning-out that excludes every other or every plurality of outline points extracted by the step of performing outline point extraction, and the step of performing trimming outline determination may be executed on the outline points after the step of performing thinning-out.

The image processing method may further include the step of performing smoothing that smoothes the outline points extracted by the step of performing outline point extraction according to positions of adjacent points of each outline point, and the step of performing trimming outline determination may be executed on the outline points after the step of performing smoothing.

A selected image region may be extracted from an original image by using a technique of extracting an attention-getting region in an image based on prescribed criteria.

Data related to an outer edge of a plurality of ovals or perfect circles, or a polygon, determined as the outline for trimming the image may be stored as vector data in a storage unit.

According to another embodiment of the present invention, there is provided an image processing apparatus including a distance conversion unit that calculates a distance value from a first pixel region on a trimming target side to a second pixel region on a background side of a binarized image, a skeleton extraction unit that extracts a plurality of points indicating a skeleton of the first pixel region according to the distance value of each first pixel, and a trimming outline determination unit that excludes a point, out of the plurality of extracted points, judged to be less significant based on prescribed conditions, draws an oval or a perfect circle according to the distance value of a pixel of each point, centered at a position of a non-excluded point, and determines an outer edge of a plurality of drawn ovals or perfect circles as an outline for trimming an image on the trimming target side.

The image processing apparatus may further include a binarization unit that binarizes an image region selected from an original image based on prescribed criteria into the first pixel region on the image trimming target side and the second pixel region on the background side, and a hole filling unit that converts a second pixel surrounded by the first pixel region into a value of the first pixel and thereby fills a hole of the first pixel region.

According to another embodiment of the present invention, there is provided an image processing apparatus including a maximum image extraction unit that extracts a maximum region in the first pixel region on the trimming target side of the binarized image, an outline point extraction unit that extracts a plurality of outline points of the extracted maximum region in the first pixel region, and a trimming outline determination unit that excludes an outline point, out of the plurality of extracted points, judged to be less significant based on prescribed conditions, and determines a polygon connecting adjacent points of non-excluded outline points as an outline for trimming the image on the trimming target side.

According to another embodiment of the present invention, there is provided a program causing a computer to implement a process including processing of calculating a distance value from a first pixel region on a trimming target side to a second pixel region on a background side of a binarized image, processing of extracting a plurality of points indicating a skeleton of the first pixel region according to the distance value of each first pixel, and processing of excluding a point, out of the plurality of extracted points, judged to be less significant based on prescribed conditions, drawing an oval or a perfect circle according to the distance value of a pixel of each point, centered at a position of a non-excluded point, and determining an outer edge of a plurality of drawn ovals or perfect circles as an outline for trimming an image on the trimming target side.

According to another embodiment of the present invention, there is provided a program causing a computer to implement a process including processing of performing maximum image extraction that extracts a maximum region in the first pixel region on the trimming target side of the binarized image, processing of performing outline point extraction that extracts a plurality of outline points of the extracted maximum region in the first pixel region, and processing of performing trimming outline determination that excludes an outline point, out of the plurality of extracted points, judged to be less significant based on prescribed conditions, and determines a polygon connecting adjacent points of non-excluded outline points as an outline for trimming an image on the trimming target side.

According to another embodiment of the present invention, there is provided an image processing system including a distance conversion unit that calculates a distance value from a first pixel region on a trimming target side to a second pixel region on a background side of a binarized image, a skeleton extraction unit that extracts a plurality of points indicating a skeleton of the first pixel region according to the distance value of each first pixel, a first trimming outline determination unit that excludes a point, out of the plurality of extracted points, judged to be less significant based on prescribed conditions, draws an oval or a perfect circle according to the distance value of a pixel of each point, centered at a position of a non-excluded point, and determines an outer edge of a plurality of drawn ovals or perfect circles as an outline for trimming an image on the trimming target side, a maximum image extraction unit that extracts a maximum region in the first pixel region on the trimming target side of the binarized image, an outline point extraction unit that extracts a plurality of outline points of the extracted maximum region in the first pixel region, a second trimming outline determination unit that excludes an outline point, out of the plurality of extracted points, judged to be less significant based on prescribed conditions, and determines a polygon connecting adjacent points of non-excluded outline points as an outline for trimming the image on the trimming target side, and a selection unit that selects one of a first outline determined by the first trimming outline determination unit and a second outline determined by the second trimming outline determination unit.

The selection unit may select one of the first outline and the second outline according to any one of conditions including (1) making random selection, (2) making selection based on a ratio of a total area of the first outline and a total area of the second outline, (3) making selection based on at least one shape of the first outline and the second outline, and (4) making selection based on an error of a shape of the first outline and a shape of the second outline with respect to the first pixel region after binarization.

According to the embodiments of the present invention described above, it is possible to shape the boundary of an image region selected based on criteria into a visually pleasing geometric outline.

### BRIEF DESCRIPTION OF THE DRAWINGS

FIG. 1 is a schematic block diagram of an image processing apparatus according to a first embodiment of the present invention.

FIG. 2A is a view showing image state during image processing according to the embodiment.

FIG. 2B is a view showing image state subsequent to FIG. 2A.

FIG. 3 is a view to describe distance conversion according to the embodiment.

FIG. 4 is a view to describe local maximum extraction according to the embodiment.

FIG. 5 is a view to describe circle drawing according to the embodiment.

FIG. 6 is a view to describe an operation of performing circle drawing while scanning an image region sequentially from the upper left.

FIG. 7 is a flowchart showing a circle trimming process according to the embodiment.

FIG. 8 is a flowchart showing a circle drawing process according to the embodiment.

FIG. 9 is a schematic block diagram of an image processing apparatus according to a second embodiment of the present invention.

FIG. 10A is a view showing image state during image processing according to the embodiment.

FIG. 10B is a view showing image state subsequent to FIG. 10A.

FIG. 10C is a view showing image state subsequent to FIG. 10B.

FIG. 11 is a view to describe smoothing according to the embodiment.

FIG. 12 is a view to describe outline point removal according to the embodiment.

FIG. 13 is a view showing image state in accordance with weighting according to the embodiment.

FIG. 14 is a flowchart showing a polygon trimming process according to the embodiment.

FIG. 15 is a flowchart showing an outline point removal process according to the embodiment.

FIG. 16 is a schematic block diagram of an image processing system according to a third embodiment of the present invention.

FIG. 17 is an example of thumbnail display of trimmed images according to the respective embodiments.

### DETAILED DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. First Embodiment (Circle Trimming: an example of trimming an image by a plurality of perfect circles)

2. Second Embodiment (Polygon Trimming: an example of trimming an image by a polygon connecting outline points)

3. Third Embodiment (System: an example of selecting either one of circle trimming or polygon trimming)

### First Embodiment

### [Image Processing Apparatus]

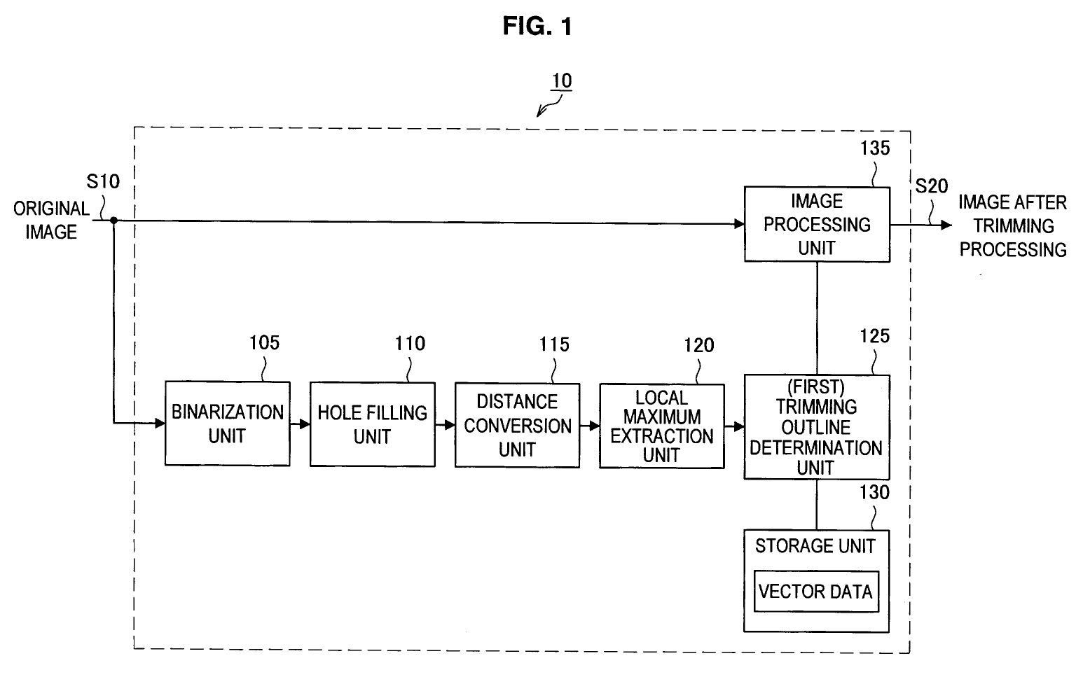

An image processing apparatus according to a first embodiment of the present invention is described hereinafter with reference to the block diagram shown in FIG. 1. An image processing apparatus 10 includes functional blocks designated by a binarization unit 105, a hole filling unit 110, a distance conversion unit 115, a local maximum extraction unit 120, a trimming outline determination unit 125 (first trimming outline determination unit), a storage unit 130, and an image processing unit 135.

The image processing apparatus 10 may include a circuit (not shown) such as an IC chip embedded in a recorder under a television or a personal computer (PC), for example. In this case, the principal function of the image processing apparatus 10 is to input a signal S10 indicating an image (original image) input to the recorder or the PC into the IC chip and outputs a signal S20 indicating an image after trimming processing to the recorder or the PC. Further, the image processing apparatus 10 may include a CPU, ROM or RAM, which is not shown. For example, a program or data containing description of processing procedure for implementing the principal function of the image processing apparatus 10 may be stored in the ROM or the like incorporated in the recorder or the PC. Then, the principal function of the image processing apparatus 10 may be realized by the CPU which reads and interprets the program and executes image processing.

Specific functions are described hereinafter. The original image to be processed hereinbelow may be various kinds of images such as an image captured by an imaging device, an image acquired through a network and an image created by a PC, for example.

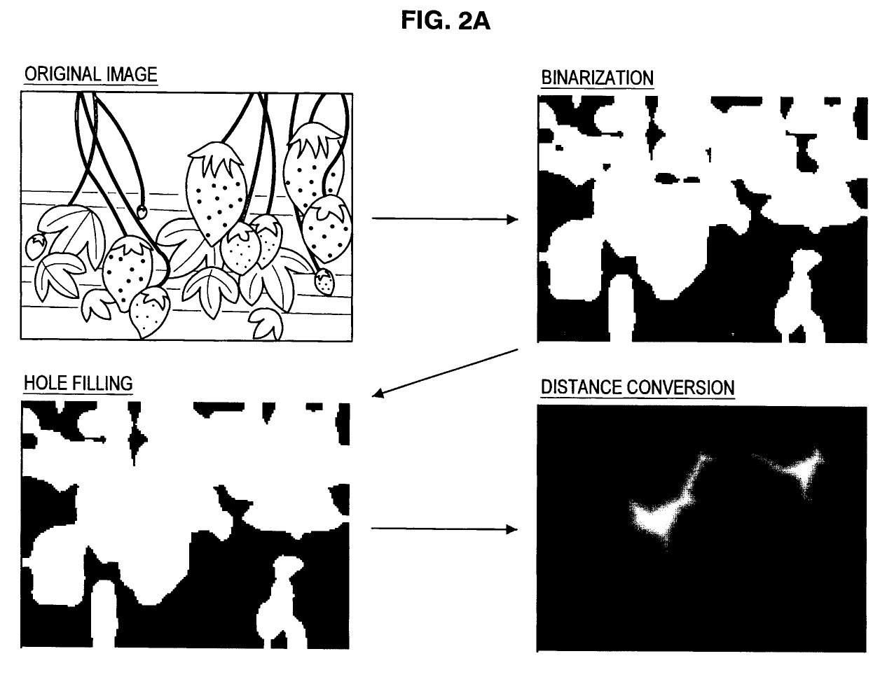

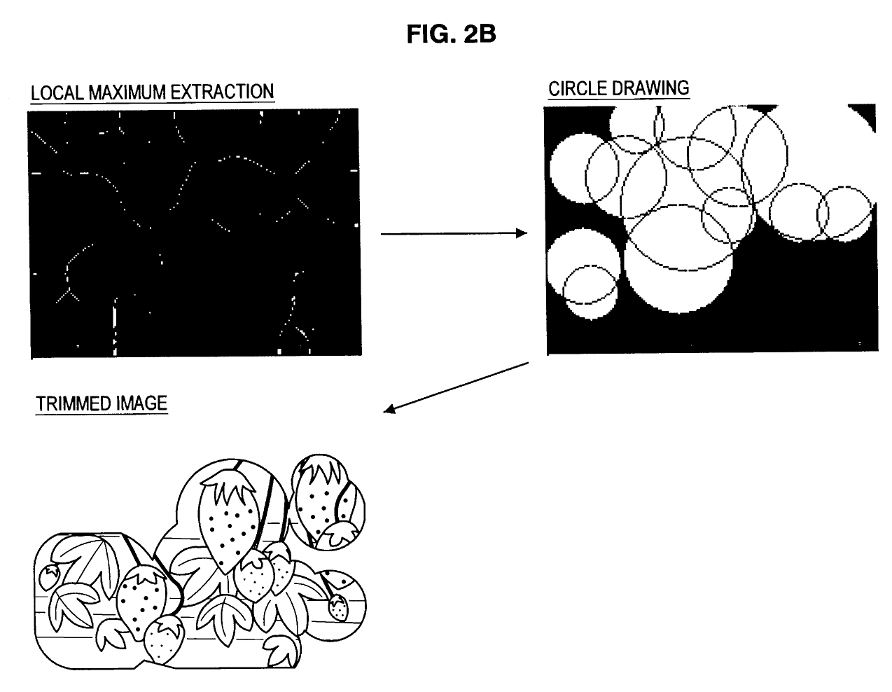

For the original image acquired in this manner, the binarization unit 105 binarizes the image region selected from the original image based on prescribed criteria. FIG. 2A shows the state where a binarized image is created from the original image. In FIG. 2A, a first pixel region on the trimming target side is represented by white, and a second pixel region on the background side is represented by black, after binarization. Methods of selecting a particular image region from the original image based on prescribed criteria include the following methods (a) to (j).

(a) A method that performs binarization by carrying out given threshold operation on luminance (or chroma, hue)

(b) A method that performs binarization based on whether it is within in a particular color range (e.g. an average color of an image)

(c) A method that extracts a moving object region in a plurality of frames that are successive in time and performs binarization into the extracted moving object region and the other object region

(d) A method that extracts a proximity object based on a distance to an object obtained by stereovision (multiple views) and performs binarization into the extracted proximity object and the other object region.

(e) A method that selects a particular region from a result of region segmentation of an image and performs binarization.

(f) A method that performs binarization based on a conspicuous region obtained as a result of using the technique called visual attention that selects a region likely to attract visual attention form an image based on the human recognition mechanism

(g) A method that performs binarization based on whether it is within in a particular frequency band (e.g. a part with an edge, a part without an edge etc.)

(h) A method that performs binarization according to a particular object region based on a result of the object recognition technique (e.g. a face recognition, human recognition etc.)

(i) A method that performs binarization based on a region obtained by extracting only the part where the depth of field is deep

(j) A method that performs binarization based on a high luminance part of an object shot by an infrared camera

The hole filling unit 110 fills a hole in a white image region by replacing a black image that is surrounded by a white image after binarization with the value of the white image. FIG. 2A shows the state where an image after hole filling is created from the binarized image.

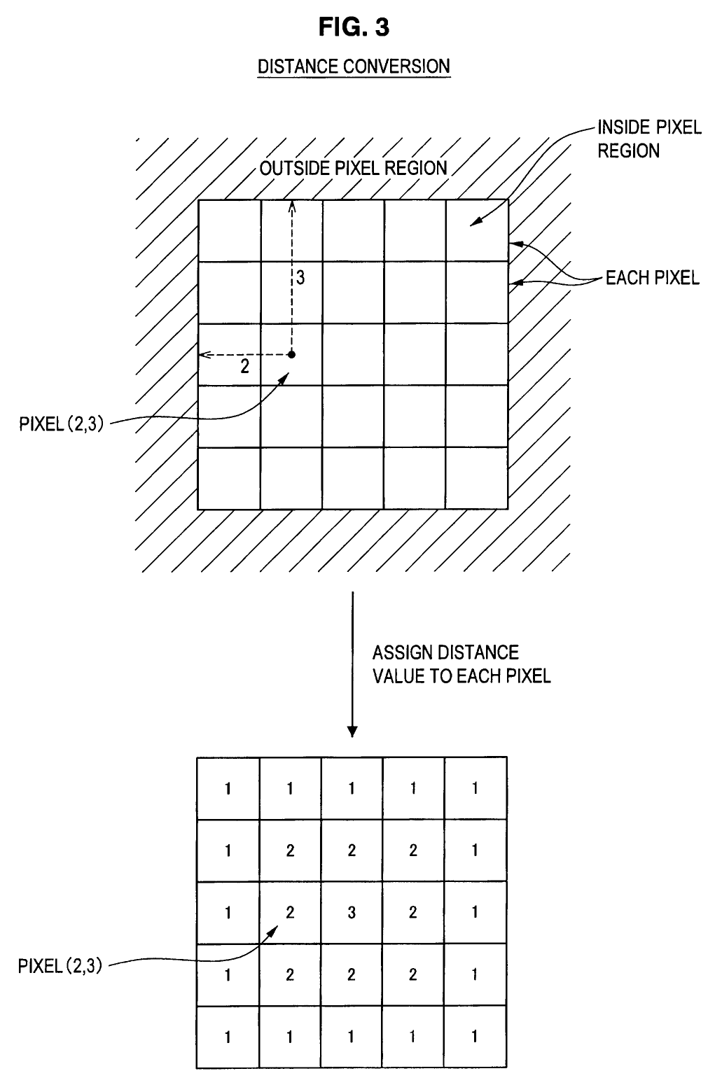

The distance conversion unit 115 calculates a distance value from a pixel in the white image region after hole filling to the nearest black pixel with respect to each white pixel. FIG. 2A shows the state where an image after distance conversion is created from the hole-filled image. The distance conversion executed therein is specifically described hereinafter with reference to FIG. 3. The distance conversion is processing of digitizing a distance from a white pixel to the nearest black pixel. For example, a distance from a white pixel (2, 3) in the image region shown in FIG. 3 to the nearest black pixel is 2. Thus, “2” indicating the distance value is substituted into the white pixel (2, 3). If this processing is performed for all white pixels inside the image region, the part inside the image region is digitized as shown in the lower part of FIG. 3.

The distance conversion unit 115 may calculate the distance value of each white pixel after image formation by the binarization and the hole filling as described above. Alternatively, the binarization and the hole filling may be performed on an image to be trimmed in advance, and the distance conversion unit 115 may calculate the distance value of each white pixel on the processed image without executing a binarization step and a hole filling step.

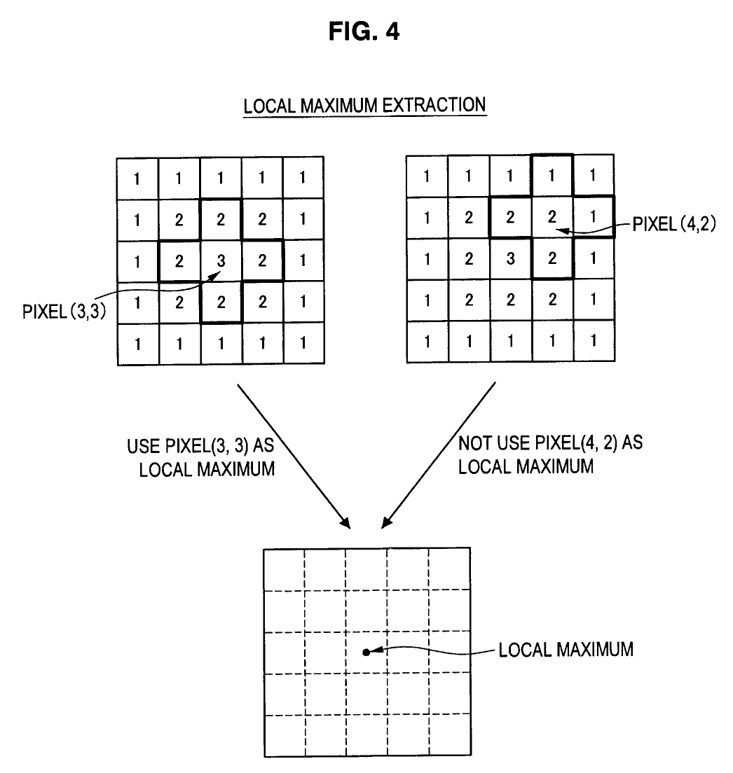

If the distance value of each white pixel is larger than the distance values of a prescribed number of white pixels that are the nearest to the white pixel, the local maximum extraction unit 120 extracts the white pixel as a local maximum. FIGS. 2A and 2B show the state where an image after local maximum extraction is created from the image after the distance conversion. The local maximum extraction executed therein is specifically described hereinafter with reference to FIG. 4. For example, the distance value of the white pixel (3, 3) is compared with the distance values of the white pixel (3, 2), the white pixel (2, 3), the white pixel (4, 3) and the white pixel (3, 4), which are the four neighborhoods that are the closest to the white pixel (3, 3) in the image region. As a result of comparison, because the distance value “3” of the white pixel (3, 3) is larger than the distance value “2” of the four neighborhoods, the white pixel (3, 3) is adopted as a local maximum. On the other hand, if the distance value of the white pixel (4, 2) is compared with the distance values of the four neighborhoods, because the distance value “2” of the white pixel (4, 2) is not larger than the distance values of the four neighborhoods, the white pixel (4, 2) is not adopted as a local maximum. This is executed for all white pixels. The eight neighborhoods, rather than the four neighborhoods, may be used as the targets of comparison. Further, the comparison may be made with a larger number of neighborhoods.

The local maximum extraction unit 120 is an example of a skeleton extraction unit that extracts a plurality of points indicating the skeleton of the first pixel region according to the distance value of each first pixel. Thus, the local maximum that is extracted by the local maximum extraction unit 120 is one example of a plurality of points indicating the skeleton that is extracted by the skeleton extraction unit. Instead of the local maximum extraction, skeleton conversion may be performed that detects the skeleton of an image, which is, the center of the distance from the boundary of the image region. The skeleton conversion is one example of the skeleton extraction unit that extracts a plurality of points indicating the skeleton of the first pixel region according to the distance value of each first pixel.

The trimming outline determination unit 125 excludes a point that is judged to be less significant among a plurality of points included in the extracted skeleton based on prescribed conditions, draws an oval or a perfect circle according to the distance value of the pixel of each point, centered at the position of a point that is not excluded, and then determines the outer edge of a plurality of drawn ovals or perfect circles as an outline for trimming the image on the trimming target side.

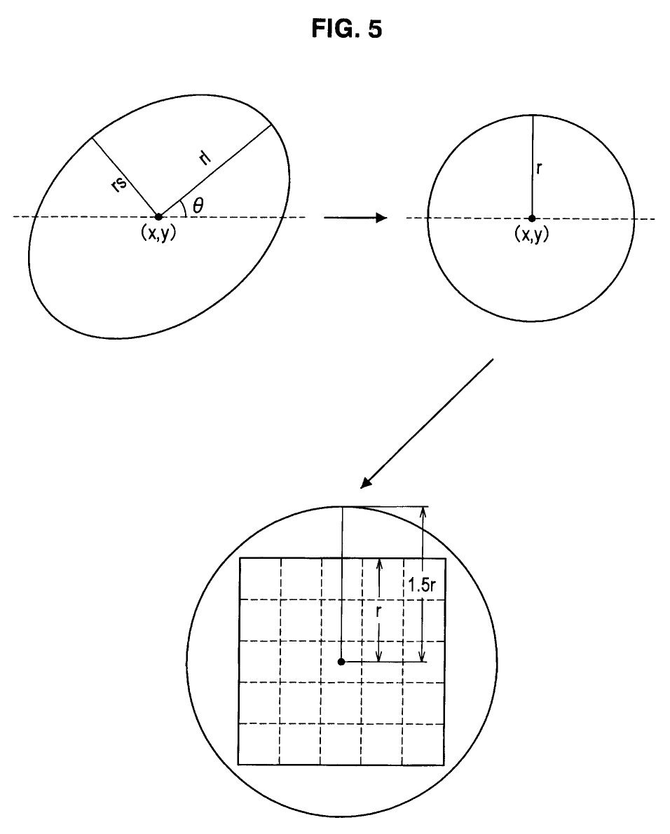

For example, as shown in FIG. 5, the trimming outline determination unit 125 may set a major axis r1, a minor axis rs and a desired rotation 0 based on the distance value and draw an oval with the center (x, y) at a local maximum that is not excluded, or, may set a radius r based on the distance value and draw a perfect circle with the center (x, y) at a local maximum that is not excluded. The radius when drawing the perfect circle is 1.5 times the distance value (radius scaling factor) in this example.

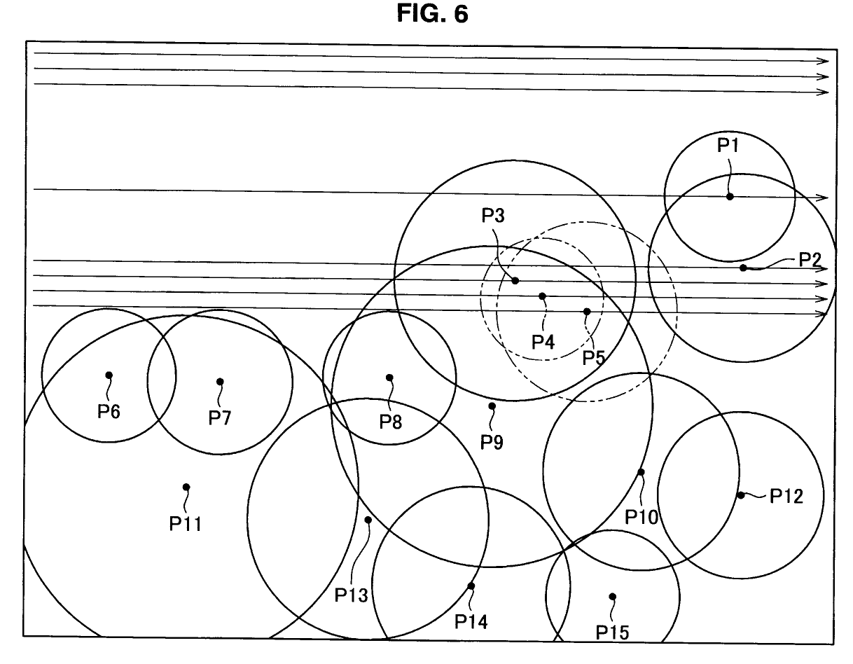

As shown in FIG. 6, the trimming outline determination unit 125 scans the selected image region sequentially from the upper left and, consequently, draws ovals or perfect circles according to the distance value of the pixel of each point in the sequence of the detected local maximums P. In the example of FIG. 6, the trimming outline determination unit 125 first draws a perfect circle centered at a local maximum P1, and then draws perfect circles centered at local maximums P2 and P3. Because local maximums P4 and P5 are located inside the perfect circle of the point P3 that has been drawn already, they are judged to be less significant and thus excluded. Further, the trimming outline determination unit 125 excludes a local maximum with the distance value that is equal to or lower than a given threshold (a drawing minimum distance value; e.g. 1/20 of the smaller one of vertical and horizontal lengths of an input image (selected image)), judging that it is less significant. In this example, the product of the drawing minimum distance value and the radius scaling factor is the minimum radius of a perfect circle. After that, the above processing is repeated, so that perfect circles centered at local maximums P6 to P15 are drawn.

A method of reducing the number of circles judged to be less significant is not limited to the above method. For example, the number of circles may be reduced by using the area of a region that does not overlap with the other circles as a score and removing circles sequentially in the ascending order of scores based on the determination that that a circle with a smaller score to be less significant. Alternatively, the number of circles may be reduced by using the proportion the area that does not overlap with the other circles as a score and removing circles sequentially in the ascending order of scores. In the case of performing the above removal method, the circles of P4 and P5 in FIG. 6 are drawn like the other circles at the time of scanning the image region sequentially from the upper left, and they are removed after that by the above removal method.

The trimming outline determination unit 125 determines the outer edge of the plurality of perfect circles (or ovals) drawn in this manner as the outline for trimming the image (FIG. 2B; circle drawing). Alternatively, the trimming outline determination unit 125 may draw at most a prescribed number of perfect circles for local maximums sequentially in the descending order of the distance value, rather than scanning the image region sequentially from the upper left.

The storage unit 130 stores vector data of region shape data of the plurality of perfect circles determined as the outline. The vector data is described later.

The image processing unit 135 overlaps a trimming target image with the outline determined based on the vector data (FIG. 2B; trimmed image). The image processing in the image processing unit 135 may include various image processing such as mask generation and image quality correction, for example, in addition to the above processing.

### [Description of Operation]

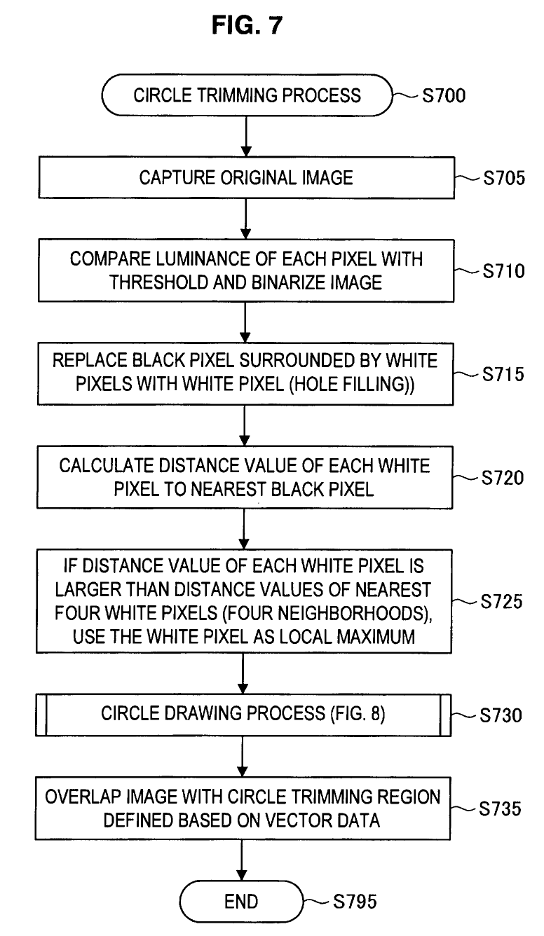

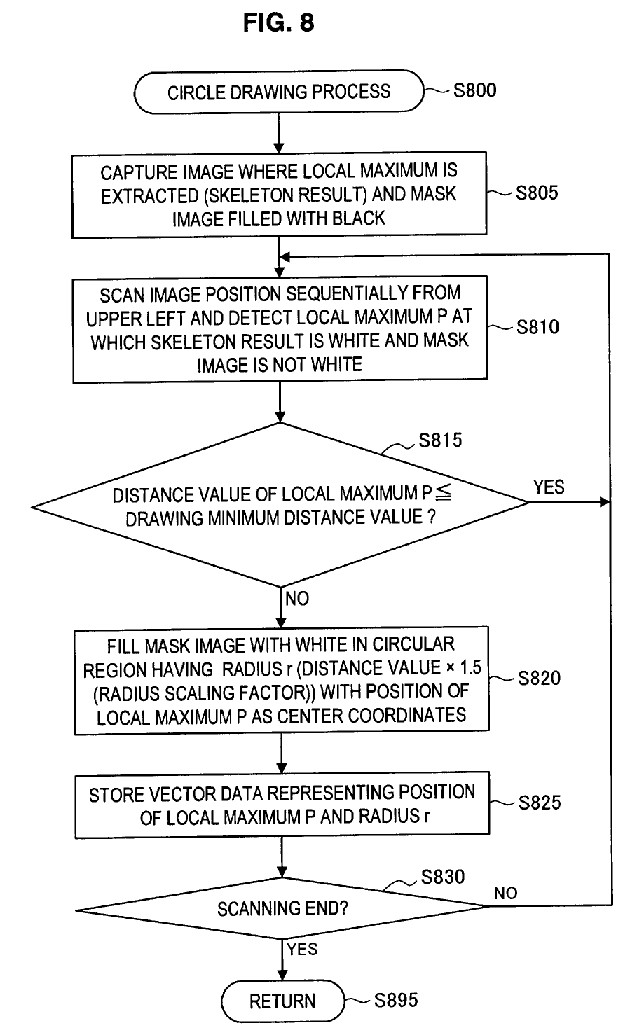

The operation of the image processing apparatus 10 is described hereinafter with reference to the flowcharts of FIGS. 7 and 8. FIG. 7 is a flowchart (main routine) showing a circle trimming process according to the embodiment. FIG. 8 is a flowchart (subroutine) showing a circle drawing process called from the circle trimming process.

### (Circle Trimming Process)

This process starts with the step S700, and captures the original image in the step S705. Next, the binarization unit 105 compares the luminance of each pixel of the original image with a given threshold, and binarizes the original image according to the magnitude relation in the step S710. The image on the trimming target side is thereby represented by white pixels.

Then, the hole filling unit 110 reverses the value of a black pixel surrounded by white pixels and replaces the black pixel with a white pixel in the step S715. The hole of the white image region is thereby filled. Further, the distance conversion unit 115 calculates the distance value of each white pixel to the nearest black pixel in the step S720. Then, the local maximum extraction unit 120 determines whether the distance value of each white pixel is larger than the respective distance values of the four white pixels (four neighborhoods) that are the closest to the relevant white pixel in the step S725. If it is larger, the local maximum extraction unit 120 adopts the white pixel as a local maximum, and if it is equal or smaller, the local maximum extraction unit 120 does not adopt the white pixel as a local maximum. The points that are set according to a change in the distance from the outline of the white image region and indicate the skeleton of the white image region are thereby selected as local maximums. After that, the circle drawing process shown in FIG. 8 is called in the step S730.

### (Circle Drawing Process)

This process starts with the step S800, and captures the image where the local maximums are extracted (skeleton result; cf. FIG. 2B) and a mask image that is filled with black in the step S805. Next, proceeding to the step S810, the trimming outline determination unit 125 scans the image position sequentially from the upper left until detecting the local maximum P at which the skeleton result is white and the mask image is not white. Then, proceeding to the step S815, the trimming outline determination unit 125 determines whether the distance value of the local maximum P is equal to or smaller than the drawing minimum distance value described above. If the distance value of the local maximum P is equal to or smaller than the drawing minimum distance value, the process returns to the step S810, and the trimming outline determination unit 125 detects the next local maximum P. This prevents drawing of a circle that is too small. As described above, the drawing minimum distance value is set to be 1/20 of the smaller one of vertical and horizontal lengths of the input image (selected image).

If the distance value of the local maximum P is larger than the drawing minimum distance value, the process proceeds to the step S820, and the trimming outline determination unit 125 fills the mask image with white in the circular region having a radius r (=distance value×1.5 (radius scaling factor)) with the position of the local maximum P as the center coordinates. Then, the storage unit 130 stores the vector data of the position of the local maximum P and the radius r in the step S825. After that, the trimming outline determination unit 125 determines whether the scanning ends in the step S830 and, if the scanning has not ended, the process returns to the step S810 to continue to perform the scanning of the local maximum P. If, on the other hand, the scanning has ended, the process proceeds to the step S895 and is thereby terminated.

After the circle drawing process is terminated, the process returns to the step S735 of FIG. 7, and the image processing unit 135 overlaps the trimming target image with the circle trimming region defined based on the vector data. The process then proceeds to the step S795 and is thereby terminated.

As described above, according to the embodiment, while a local maximum that is judged to be less significant based on prescribed conditions is excluded, a perfect circle according to the corresponding distance value is drawn for each local maximum, centered at the position of the local maximum that is not excluded. The outer edge of a plurality of drawn perfect circles is determined as the outline for trimming the image that is the feature part drawn in the selected image region. It is thereby possible to shape the region in the image selected based on certain criteria into the region shape formed by a plurality of circles. Particularly, in this embodiment, because the points of the skeleton that are judged to be less significant based on prescribed conditions are excluded, an arc-shaped fine protrusion is eliminated in the outline for trimming the image. As a result, it is possible to shape the boundary of the region in the selected image into a visually pleasing arc-shaped outline.

Instead of drawing the perfect circle with the center (x, y) at a local maximum, the oval with the center (x, y) at a local maximum may be drawn by setting a major axis r1, a minor axis rs and a desired rotation θ based on the distance value (cf. FIG. 5). It is thereby possible to trim the image with a surprising, attractive and rhythmical circular outline by varying the ratio between the major axis r1 and the minor axis rs or varying the rotation θ.

### Second Embodiment

### [Image Processing Apparatus]

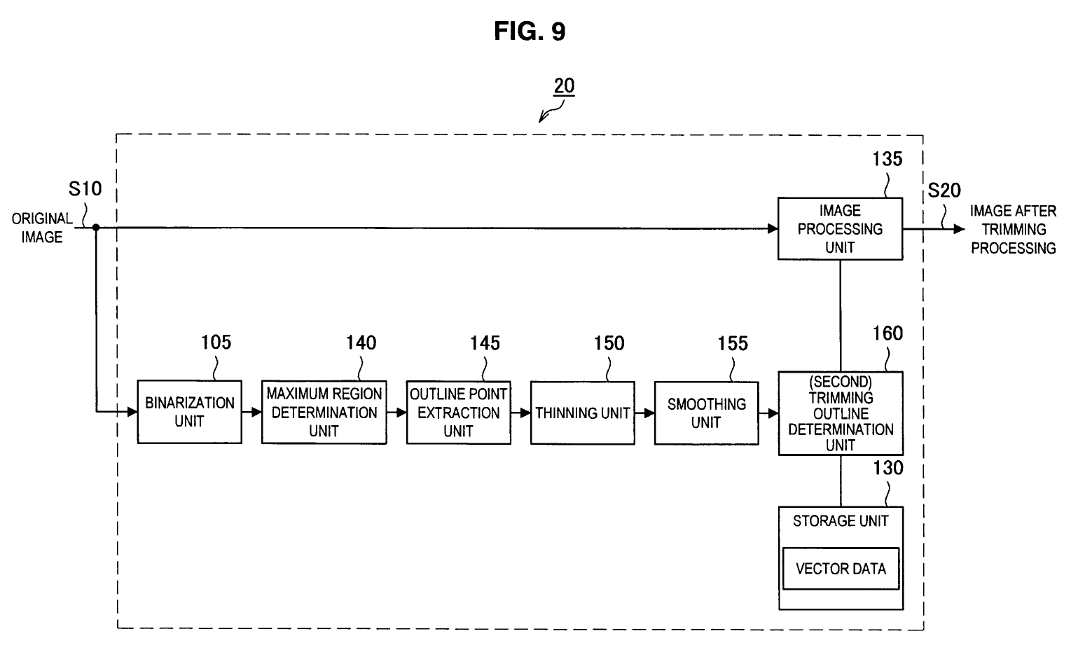

An image processing apparatus according to a second embodiment of the present invention is described hereinafter with reference to the block diagram shown in FIG. 9. The second embodiment is different from the first embodiment in that an image processing apparatus 20 according to the second embodiment trims an image by a polygon while the image processing apparatus 10 according to the first embodiment trims an image by a plurality of perfect circles. The second embodiment is described hereinafter mainly about the difference.

The image processing apparatus 20 includes functional blocks designated by a binarization unit 105, a maximum region determination unit 140, an outline point extraction unit 145, a thinning unit 150, a smoothing unit 155, a trimming outline determination unit 160 (second trimming outline determination unit), a storage unit 130 and an image processing unit 135.

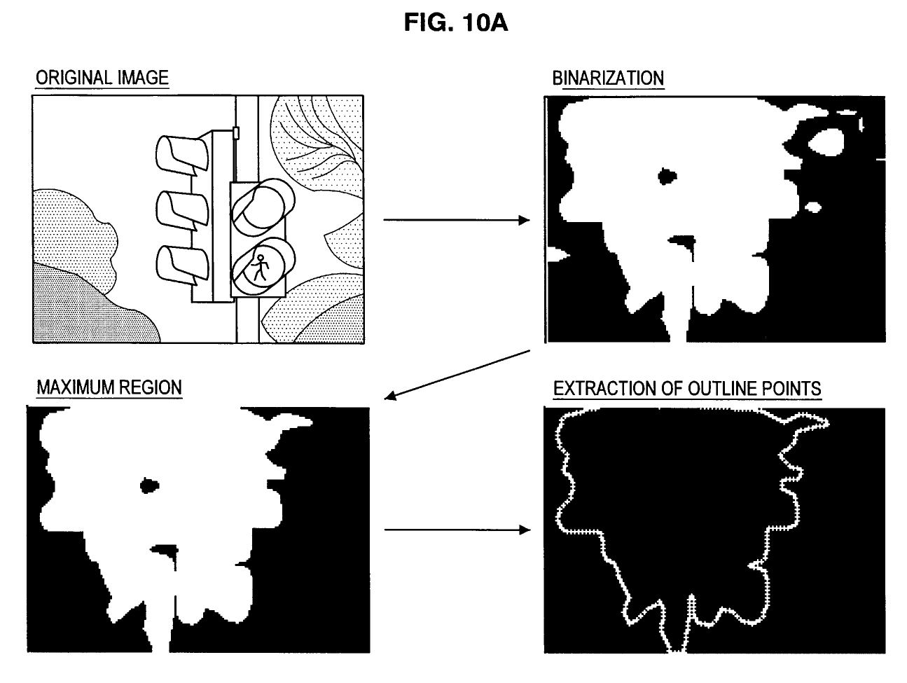

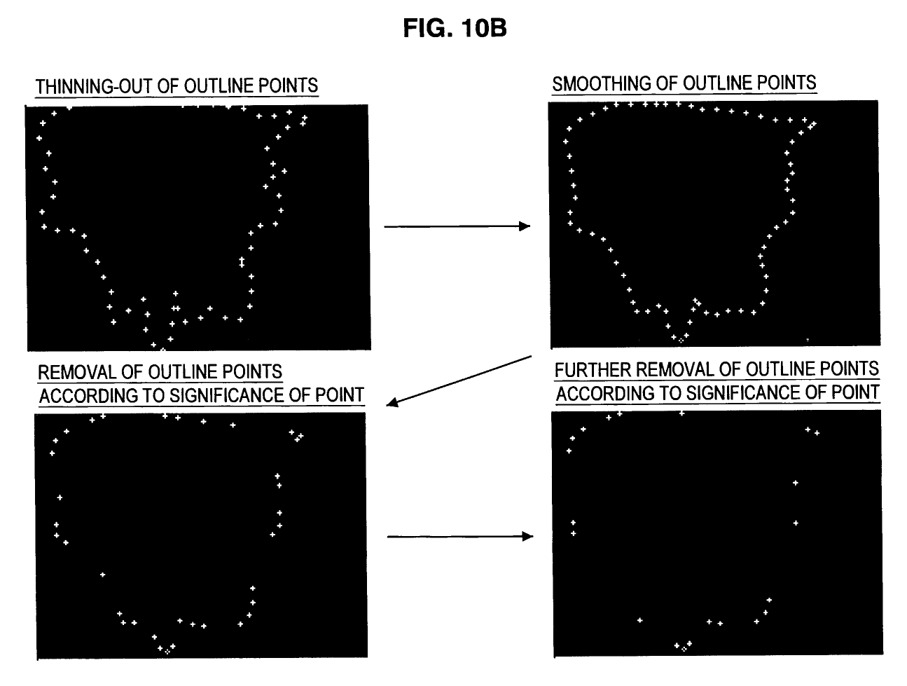

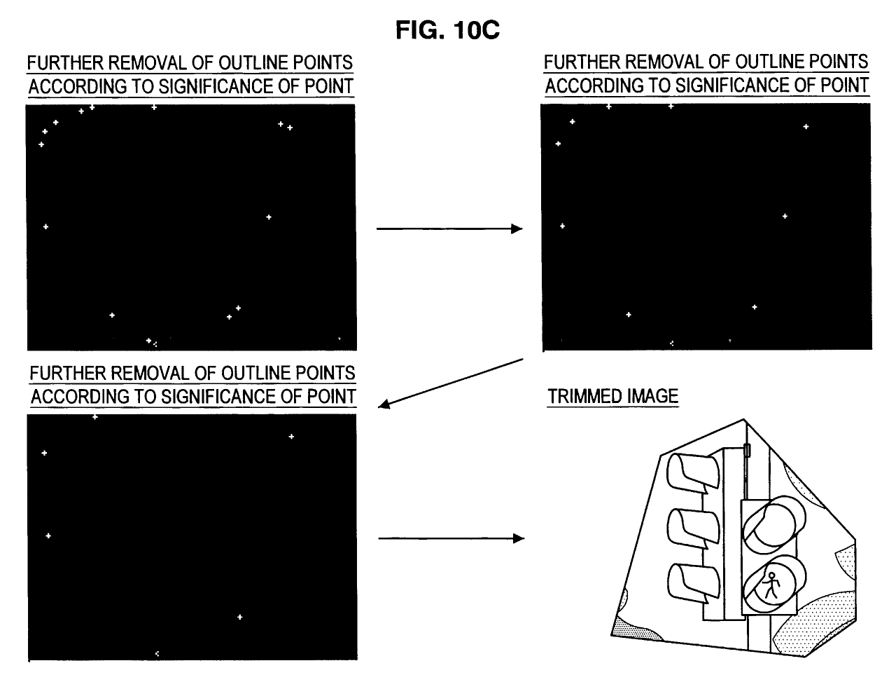

For the binarized image region of the original image as shown in FIG. 10A, the maximum region determination unit 140 replaces an image different from the image in the maximum region of the white image region with the value of a black image and thereby extracts the maximum region of the white image (FIG. 10A; maximum region). The outline point extraction unit 145 extracts a plurality of outline points of the maximum region of the white image (FIG. 10A; extraction of outline points). The maximum region determination unit 140 may extract the maximum region of the white image from the image that is binarized in advance (without executing the step of performing binarization of the image).

The thinning unit 150 equally excludes every other or every plurality of outline points until the number of outline points extracted by the outline point extraction unit 145 becomes a prescribed number. In this embodiment, the operation of thinning out every other outline point is repeated until the number of outline points becomes equal to or smaller than the maximum number of points after thinning-out. The maximum number of points after thinning-out is set to “100” in this embodiment (FIG. 10B; thinning-out of outline points).

The smoothing unit 155 smoothes the outline points that are thinned out by the thinning unit 150 based on the positions of adjacent points of each outline point. Specifically, an outline point Pi is smoothed by the following expression (1) based on the positions of an adjacent point Pi−1 and an adjacent point Pi+1:

Pi=(Pi−1+Pi+Pi+1)/3 (1)

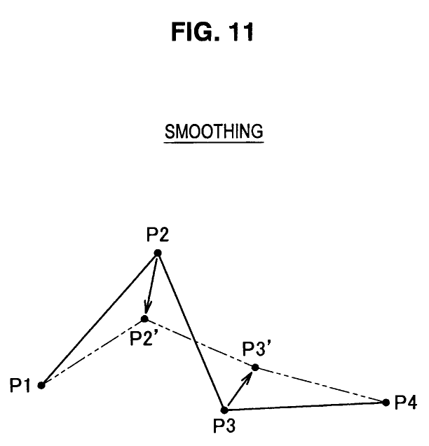

For example, as shown in FIG. 11, an outline point P2 is smoothed into P2′ based on the positions of adjacent points P1 and P3, and the outline point P3 is smoothed into P3′ based on the positions of the adjacent points P2 and P4. The smoothing unit 155 performs the smoothing for all outline points (FIG. 10B; smoothing of outline points). The image processing implemented by the thinning unit 150 and the smoothing unit 155 may be omitted.

The trimming outline determination unit 160 excludes an outline point that is judged to be less significant among a plurality of extracted outline points based on prescribed conditions (FIGS. 10B, 10C; removal of outline points according to significance of point), and determines a polygon connecting the adjacent points of the outline points that are not excluded as an outline for trimming the trimming target image (FIG. 10C, removal of outline points according to significance of point (final)).

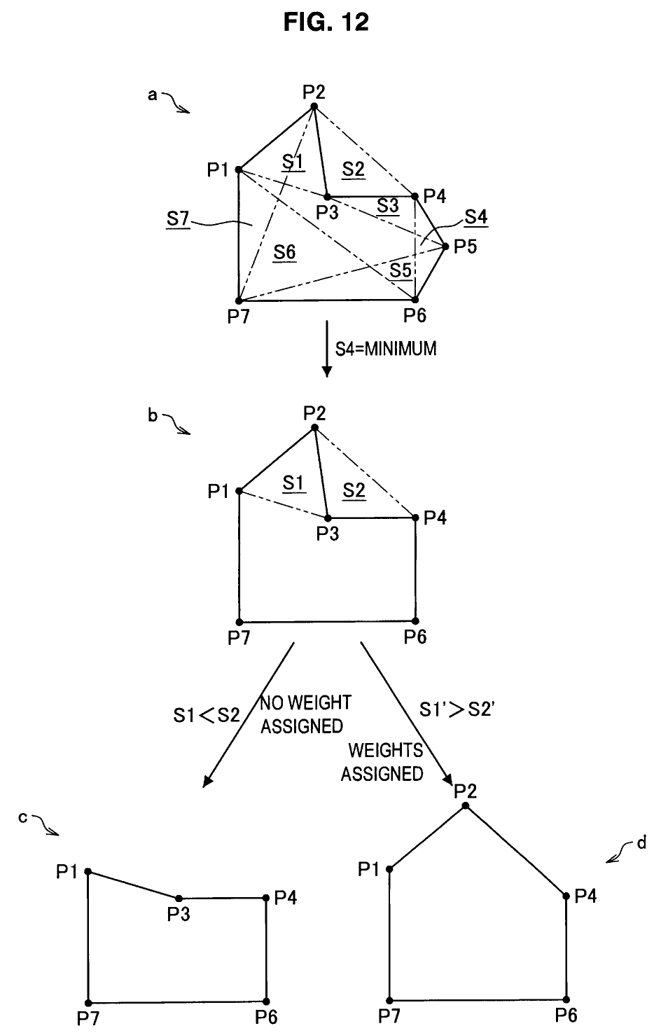

A method of excluding less significant outline points based on prescribed conditions is described hereinbelow. If the area of a triangle formed by three adjacent outline points among the outline points is the smallest, the trimming outline determination unit 160 excludes the outline point located in the middle of the three outline points forming the apexes of the area, judging that it is less significant. More specifically described with reference to FIG. 12, regarding outline points P1 to P7 shown in “a” of FIG. 12, if areas of triangles of adjacent three points S1(P1, P2, P3), an area S2(P2, P3, P4), an area S3(P3, P4, P5), an area S4(P4, P5, P6), an area S5(P5, P6, P7),an area S6(P6, P7, P1) and an area S7(P7, P1, P2) are compared, the area S4 is the smallest. In this case, the trimming outline determination unit 160 determines P5 to be less significant and excludes P5 as shown in “b” of FIG. 12 (FIGS. 10B, 10C, removal of outline points, trimmed image)

In the description above, it is not considered whether the part forming a triangle is a projection or a hollow of the region inside outline points. In the case of not suppressing a hollow of the region inside outline points as described above, no weight is assigned to determination of the significance. Thus, if the area S1 and the area S2 shown in “b” of FIG. 12 are compared directly, and, as a result, the area S1 is smaller, the trimming outline determination unit 160 determines P2 to be less significant and excludes P2.

On the other hand, in the case of suppressing a hollow of the region inside outline points, weights are assigned to determination of the significance, and therefore a result may be different. For example, when weights to a projection is 1,0 and weights to a hollow is 0.5 in order to suppress the hollow, if areas after assigning weights to the areas S1 and S2 are S1′ and S2′, the area S2 is smaller in the state of “b” of FIG. 12. In this case, the trimming outline determination unit 160 determines P3 to be less significant and excludes P3 as shown in “d” of FIG. 12. As a result, the hollow of the region inside outline points is suppressed in “d” of FIG. 12 in which weighing for suppressing the hollow is performed compared to “c” of FIG. 12 in which weighing for suppressing the hollow is not performed.

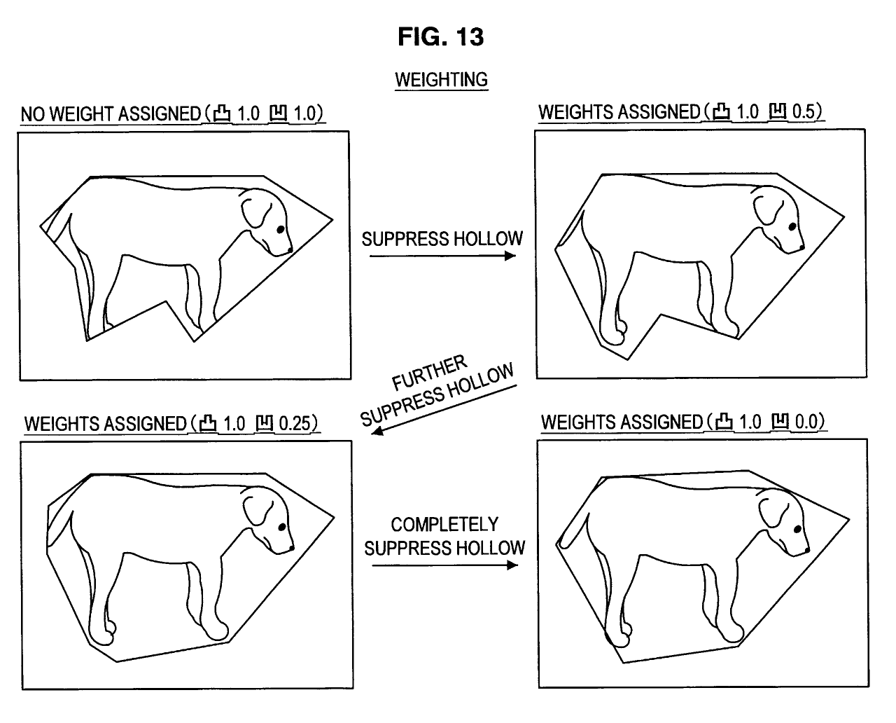

An example of a difference between trimming results due to a difference in assigned weights is described hereinafter. For example, FIG. 13 shows examples of outlines of the image in the case of assigning no weight (weights to a protrusion: 1.0, weights to a hollow: 1.0), the case of assigning weights for suppressing a hollow (weights to a protrusion: 1.0, weights to a hollow: 0.5), the case of assigning weights for further suppressing a hollow (weights to a protrusion: 1.0, weights to a hollow: 0.25) and the case of assigning weights for completely suppressing a hollow (weights to a protrusion: 1.0, weights to a hollow: 0.0). Thus, the outlines with different trimmed edges can be formed according to the degree of suppressing a hollow. Any of the outlines is attractive, and in the trimming where weights to a protrusion is 1.0 and weights to a hollow is 0.5, for example, the image is trimmed into a polygon in which the tail of a dog in a target image is slightly cut. In this manner, it is possible in this embodiment to trim the target image in the feeling that a person cuts out the image freely with scissors. This enables image representation like handmade that is visually appealing.

### [Description of Operation]

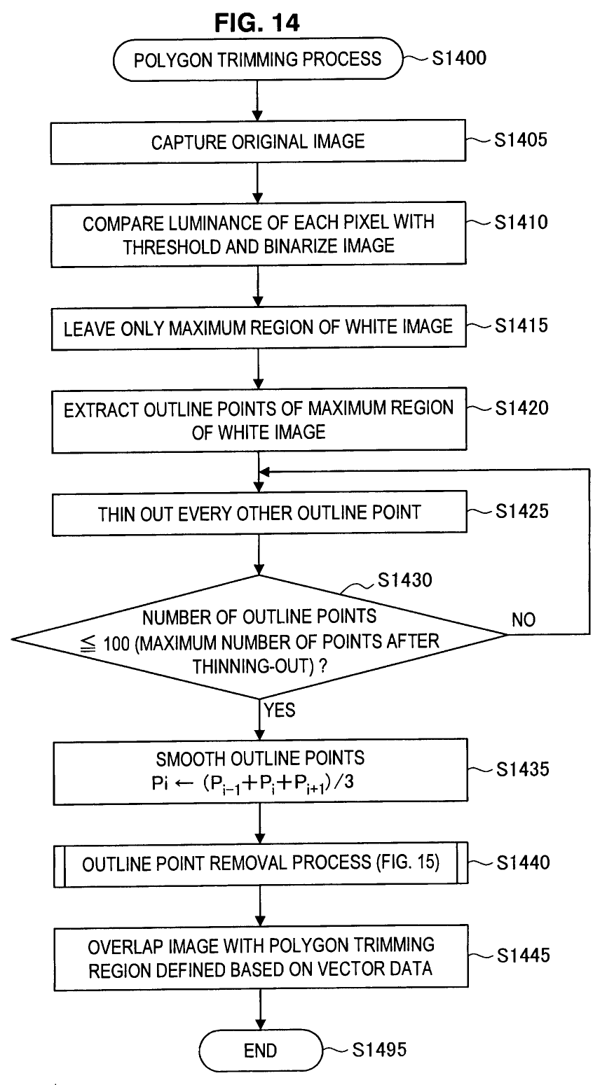

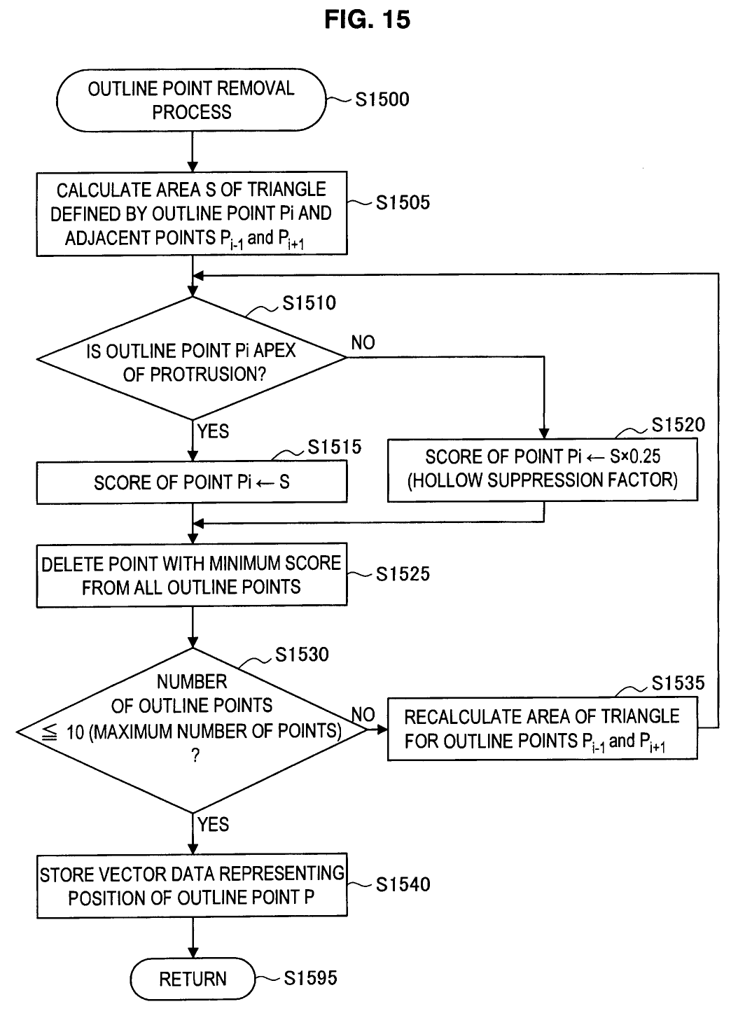

The operation of the image processing apparatus 20 is described hereinafter with reference to the flowcharts of FIGS. 14 and 15. FIG. 14 is a flowchart (main routine) showing a polygon trimming process according to the embodiment. FIG. 15 is a flowchart (subroutine) showing an outline point removal process called from the circle trimming process of FIG. 14.

### (Polygon Trimming Process)

This process starts with the step S1400, and captures the original image in the step S1405. Next, the binarization unit 105 compares the luminance of each pixel of the original image with a given threshold, and binarizes the original image according to the magnitude relation in the step S1410.

Next, the maximum region determination unit 140 reverses the region different from the maximum region of the white pixel region into the value of a black pixel, thereby leaving only the maximum region of the white image in the step S1415. Then, the outline point extraction unit 145 extracts a plurality of outline points of the extracted maximum region of the white image in the step S1420.

Then, in the step S1425, the thinning unit 150 thins out every other extracted outline point. Further, the process proceeds to the step S1430, and the thinning unit 150 repeats the steps S1425 and S1430 while the number of points after thinning-out is larger than the maximum number of points after thinning-out (“100” in this example). If the number of points after thinning-out becomes equal to or smaller than the maximum number of points after thinning-out, the process proceeds to the step S1435, and the smoothing unit 155 smoothes the outline points according to the above expression (1). After that, the outline point removal process (subroutine) is called in the step S1440.

### (Outline Point Removal Process)

This process starts with the step S1500, and the trimming outline determination unit 160 calculates the area S of a triangle connecting three points, which is, every outline point Pi and adjacent points Pi−1 and Pi+1, in the step S1505. Next, the process proceeds to the step S1510, and the trimming outline determination unit 160 determines whether the outline point Pi is the apex of a protrusion. If it is the apex, the process proceeds to the step S1515 and uses the calculated area S of the outline point Pi as the score of the point Pi. If, on the other hand, it is not the apex, the process proceeds to the step S1520 and uses the value obtained by assigning weights to the calculated area S of the outline point Pi as the score of the point Pi. The weights are 0.25 in this example.

The process further proceeds to the step S1525, and the trimming outline determination unit 160 deletes the point having the minimum score from all the outline points. Then, in the step S1530, if the number of outline points is larger than the maximum number of outline points (“100” in this example), the process further proceeds to the step S1535 and recalculates the area of a triangle for the outline points Pi−1 and Pi+1, and then returns to the step S1510. As a result that a certain point is deleted in the step S1525, the areas of triangles centered at the points (outline points Pi−1 and Pi+1) at both sides of the deleted point change, and therefore the areas of triangles are recalculated for the respective changed outline points Pi−1 and Pi+1 in the step S1535. In this manner, the processing of the steps S1510 to S1535 is repeated while the number of outline points is larger than the maximum number of points in the step S1530. If the number of outline points becomes equal to or smaller than the maximum number of points, the process proceeds to the step S1540, and stores the vector data representing the position of the outline point P into the storage unit 130. The process then proceeds to the step S1595 and is thereby terminated.

After the outline point removal process is terminated, the process returns to the step S1445 of FIG. 14, and the image processing unit 135 overlaps the trimming target image with the polygon trimming region defined based on the vector data. The process then proceeds to the step S1495 and is thereby terminated.

As described in the foregoing, according to the embodiment, while outline points that are judged to be less significant based on prescribed conditions are excluded among a plurality of outline points P indicating the outline of the white pixel region, and a polygon connecting the adjacent points of an outline point that is not excluded is determined as the outline for trimming the image on the target side. Because the less significant outline points P are excluded, the outline can be shaped into the polygonal region shape having only the significant outline points as the apexes. Specifically, because triangles are sequentially deleted in the ascending order of the area, the polygon formed by a smaller number of points can be created while maintaining the shape of the original binarized image on the trimming target side as much as possible. It is thereby possible to trim the image on the trimming target side into a daring and pleasing outline as if a person cuts out the image freely with scissors, for example.

The operation of the thinning unit 150 in the steps S1425 and S1430 may be omitted. Likewise, the operation of the smoothing unit 155 in the step S1435 may be also omitted. In the case of not suppressing a hollow, the operation of the trimming outline determination unit 160 in the steps S1510 to S1520 is not performed.

Further, although the number of outline points is set to be ten, for example, as the conditions for terminating the removal of outline points in the step S1530, another termination determination method may be used. For example, the removal of outline points may be terminated when the absolute values of all outline points (apex) angle becomes equal to or smaller than a certain angle (e.g. 150 degrees).

Furthermore, a polygon in which the area of the polygon formed by three or more adjacent outline points is the smallest may be detected among the outline points, and an outline point located in the middle of the three or more outline points forming the detected polygon may be judged to be less significant and excluded. For example, a quadrangle shape in which the area of the quadrangle formed by four outline points is the smallest may be detected, and two outline points located in the middle of the four outline points of the detected quadrangle may be excluded.

According to the circle trimming of the first embodiment and the polygon trimming of the second embodiment, it is possible to shape the boundary of a selected image region into a visually pleasing geometric outline. In the case of “shaping the region boundary of the image”, the shape before shaping (which is, the binarized state) exists as a precondition. Thus, according to these embodiments, it is possible to neatly shape the boundary shape while maintaining the information of the binarized image on the trimming target side.

### Third Embodiment

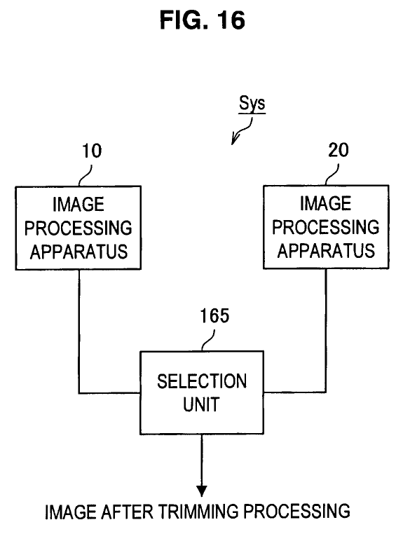

In a third embodiment of the present invention, an image processing system that selects the outline for trimming an image from the circle trimming region and the polygon trimming region is described. As shown in FIG. 16, an image processing system Sys includes the image processing apparatus 10 according to the first embodiment, the image processing apparatus 20 according to the second embodiment, and a selection unit 165.

The selection unit 165 selects either one of the circle trimming region (first outline) that is determined by the image processing apparatus 10 or the polygon trimming region (second outline) that is determined by the image processing apparatus 20 as the outline for trimming an image on the trimming target side.

Examples of selection conditions include the following (1) to (5).

(1) Make random selection

(2) Select a result of the one having a larger total area of the circle trimming region and the polygon trimming region

(3) Select a result of the one having a smaller error between the binarized region (or, the image after hole filling in the case of circle, the image after maximum region selection in the case of polygon) and the circle trimming region or the polygon trimming region obtained as a result

(4) Perform the polygon trimming with an appropriate hollow suppression rate firstly and, if the number of apexes of a hollow is equal to or larger than a certain number (or, if the apex of a hollow at the acute angle exists etc.), select the circle trimming region; otherwise, select the polygon trimming region

(5) If the white image region is made up of a plurality of small regions as a result of binarization, select the circle trimming region; otherwise, select the polygon trimming region.

According to the first to third embodiments described above, it is possible to automatically select a preferred one of the circle trimming and the polygon trimming. Consequently, it is possible to shape the region in the image that is selected based on certain criteria into the region shape formed by a plurality of circles by means of circle putting using the distance conversion. It is further possible to shape the region in the image that is selected based on certain criteria into the polygonal region shape by thinning out points based on the degree of significance of each point in the point sequence forming the region outline.

This enables representation of image data as non-rectangular data. Particularly, because representation that emphasizes a trimmed part is enabled by trimming a part of the region in the image, it is possible to realize eye-delighting and heart-attracting image representation.

As region selection criteria, a technique of selecting an attention-getting region in an image (e.g. visual attention) may be used. With such a technique, an image is created by extracting the attention-getting region from the original image. On the created image serving as the image region selected based on prescribed criteria, the above-described image processing such as binarization, distance conversion, skeleton conversion and trimming outline determination is performed. This enables representation that further emphasizes the attention-getting region in the image.

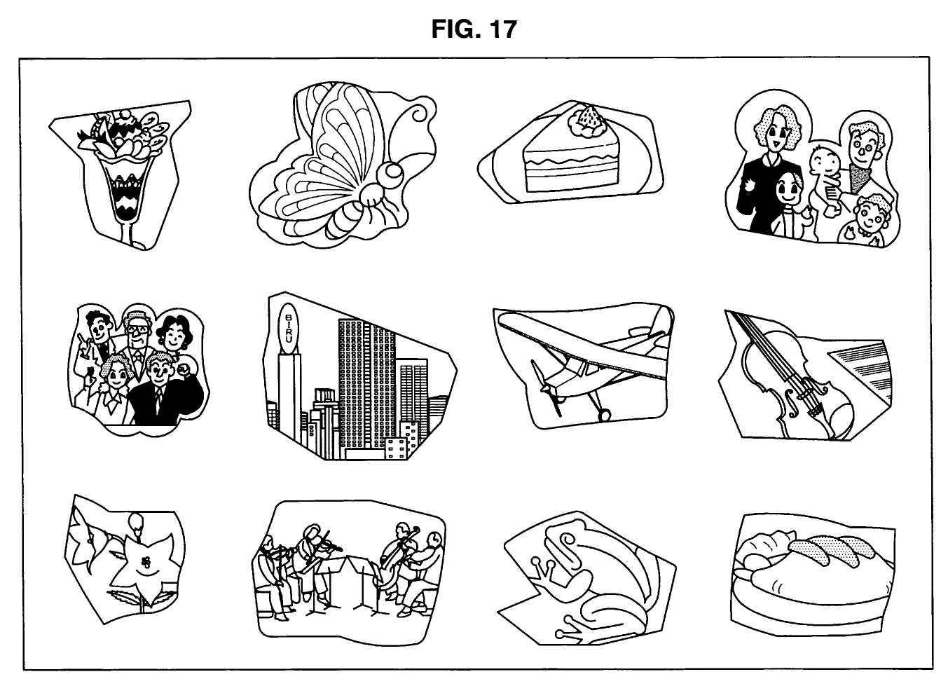

Uses of trimmed images created by the above-described embodiments include the followings. For example, the trimmed images may be used as a substitute for thumbnail display that displays a plurality of images in a list as shown in FIG. 17.

For example, an image placed on an auction site has been represented in a shape such that an item can be enclosed within a rectangular frame. Therefore, the image is represented by the same rectangular shape or a quadrangular shape after affine transformation or projective transformation in a display device. However, although data is turned out to be stored as image information in a rectangular shape, an eye-catching object in the stored image originally has an indefinite shape, not the rectangular shape, in most cases. Therefore, if it is necessary to handle images always in a quadrangular shape, flexibility in design is low, failing to offer fun.

Further, in use of rectangular thumbnail images, if the images are arranged with no space therebetween, the background is completely hidden. Further, even with a space therebetween, the background is visible only through the space of the lattice. On the other hand, with use of the trimmed images shown in FIG. 17, a space exists between the images even if the images are simply arranged in a uniform pattern because the images are not rectangular. This allows an effective use of the background as a part of design.

Furthermore, if a plurality of rectangular images are arranged in a non-uniform manner, a useless space is produced therebetween or a part of the image overlaps with another image. On the other hand, by the image trimming with use of the image processing method according to the embodiments, it is possible to arrange images in a non-uniform pattern that is fun to the eye without any useless space.

Further, the trimmed images may be used when representing images like a scrapbook. Because cutting out a photograph with scissors when creating a paper scrapbook is customarily performed, by installing an application for executing a method that imitates this on a computer, a scrapbook can be implemented on the computer.

In the representation that imitates a scrapbook on a computer used heretofore, a technique of putting a photograph on a frame in a previously prepared shape is employed. On the other hand, with use of the trimmed images according to the embodiments, it is possible to realize representation in which the images are trimmed by the trimming method in consideration of the contents of the images.

Furthermore, the trimmed images may be used for creating one collage image by using a plurality of trimmed images. The trimmed images may be also used as stickers in the real world.

In addition, the trimmed images may be used to serve as one-point illustration or icon in the situation of displaying another item, not in the situation of representing the trimming target image itself.

Information of the region shapes obtained in the respective embodiments may be stored as the vector data into the storage unit 130 in the following format, for example. Circle trimming data is represented as follows.

(1) Define an “oval” shape in order to represent the circle trimming data. A circle is represented as an oval for the purpose of flexibly dealing with the expansion and contraction of images in the vertical and horizontal directions. Further, hold center coordinates cx, cy and radii rx and ry in the horizontal and perpendicular directions as parameters of the oval. Each of these values is represented by a relative value to the width and height of the image during execution of circle trimming, which is the value of 0.0 to 1.0.

(2) The circle trimming data can be represented by a plurality of ovals representing the circle used in circle putting with the center coordinates and the radii in the horizontal and perpendicular directions as described above and the number of ovals.

Polygon trimming data is represented as follows.

(1) Define a “point” shape in order to represent the polygon trimming data. Further, hold position coordinates x, y at the point as parameters of the point. Each of these values is represented by a relative value to the width and height of the image during execution of polygon trimming, which is the value of 0.0 to 1.0.

(2) The polygon trimming data can be represented by a plurality of points forming the apexes of the polygon and the number of points.

By storing the region shape data obtained as a result of the above-described image processing as the vector data in this manner, it is possible to store the data of the circle trimming region and the polygon trimming region without being affected by an image size for use. Because of being the vector data, the region shape and the image for which the region shape is used can be managed independently of each other, and the data can be stored without being affected by the expansion and contraction of the image.

In the above embodiments, the operations of the respective units are related to each other and may be replaced with a series of operations in consideration of the relation to each other. The embodiment of the image processing method can be thereby converted into an embodiment of an image processing method and an embodiment of a program for causing a computer to implement the functions of the image processing method.

The present application contains subject matter related to that disclosed in Japanese Priority Patent Application JP 2008-227881 filed in the Japan Patent Office on Sep. 5, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

For example, although the trimmed image according to the embodiments of the present invention can be used as it is, the trimmed image may be enlarged to the size that is equivalent to the size of the original quadrangle because the region area becomes smaller than the original quadrangle as a result of trimming. In such a use, the effect of emphasized display of the region selected by trimming can be obtained.

Further, in an embodiment of the present invention, an image may be trimmed into a circular shape based on a set of combinations of circles toward the inside and circles toward the outside of the image, not limited to based on a set of circles toward the outside of the image. For example, if the circle centered at the local maximum P1 of FIG. 6 is a circle toward the inside of the image, the outline that hollows out the circle centered at the local maximum P2 can be formed. However, the circle toward the inside of the image is trimmed in the direction to hollow out the image on the trimming target side. Therefore, it is preferred to impose a limitation such as not applying the circle toward the inside of the image to a circle centered at a point located at the center of the image on the trimming target side or a circle having a radius that is equal to or larger than a prescribed radius.

Furthermore, in an embodiment of the present invention, when trimming an image into a polygonal shape, an outline point and an outline point may be connected by a curved line, not limited to a straight line. In addition, processing of rounding the apex (outline point) of the polygon that is obtained as result of the processing according to the embodiment of the present invention may be performed.

What is claimed is:

1. An image processing method comprising the steps of:
performing distance conversion that calculates a distance value from a first pixel region on a trimming target side to a second pixel region on a background side of a binarized image;
performing skeleton extraction that extracts a plurality of points indicating a skeleton of the first pixel region according to the distance value of each first pixel; and
performing trimming outline determination that excludes a point, out of the plurality of extracted points, judged to be less significant based on prescribed conditions, draws an oval or a perfect circle according to the distance value of a pixel of each point, centered at a position of a non-excluded point, and determines an outer edge of a plurality of drawn ovals or perfect circles as an outline for trimming an image on the trimming target side.

2. The image processing method according to claim 1, wherein the step of performing trimming outline determination excludes a point, out of the plurality of extracted points, located inside an oval or a perfect circle already drawn, judging the point to be less significant.

3. The image processing method according to claim 1, wherein the step of performing trimming outline determination excludes a point, out of the plurality of extracted points, where the distance value of a pixel of each point is equal to or smaller than a given threshold, judging the point to be less significant.

4. The image processing method according to claim 1, wherein the step of performing trimming outline determination draws an oval or a perfect circle according to the distance value of a pixel of each point in a sequence of points, out of the plurality of extracted points, detected by scanning a selected image region sequentially from an upper left.

5. The image processing method according to claim 1, wherein the step of performing trimming outline determination draws a prescribed number of ovals or perfect circles according to the distance value in a sequence of points of pixels having a larger distance value, out of the plurality of extracted points.

6. The image processing method according to claim 1, further comprising the steps of:
performing binarization by binarizing an image region selected from an original image based on prescribed criteria into the first pixel region on the image trimming target side and the second pixel region on the background side; and
performing hole filling by filling a hole of the first pixel region by converting a second pixel surrounded by the first pixel region into a value of the first pixel,
wherein the step of performing distance conversion calculates a distance value from each first pixel of the first pixel region where the hole is filled by the step of performing hole filling to the second pixel region.

7. An image processing method comprising the steps of:
performing maximum image extraction that extracts a maximum region in the first pixel region on the trimming target side of the binarized image;
performing outline point extraction that extracts a plurality of outline points of the extracted maximum region in the first pixel region; and
performing trimming outline determination that excludes an outline point, out of the plurality of extracted points, judged to be less significant based on prescribed conditions, and determines a polygon connecting adjacent points of non-excluded outline points as an outline for trimming an image on the trimming target side.

8. The image processing method according to claim 7, wherein the step of performing trimming outline determination detects a polygon where an area of a polygon formed by three or more adjacent outline points, out of the plurality of extracted points, is smallest, and excludes an outline point located in middle of three or more outline points forming the detected polygon, judging the outline point to be less significant.

9. The image processing method according to claim 8, wherein the step of performing trimming outline determination assigns different weights to an area of a triangle formed by three or more adjacent outline points, out of the plurality of extracted points, depending on whether the triangle forms either one of a protrusion or a hollow of a polygon connecting adjacent points of the plurality of outline points, detects a triangle where an area after assigning weights is smallest, and excludes an outline point located in middle of three outline points forming the detected triangle, judging the outline point to be less significant.

10. The image processing method according to claim 7, wherein the step of performing trimming outline determination ends if the number of outline points becomes equal to or smaller than a prescribed number as a result of repeating excluding an outline point judged to be less significant.

11. The image processing method according to claim 7, further comprising the step of performing thinning-out that excludes every other or every plurality of outline points extracted by the step of performing outline point extraction,
wherein the step of performing trimming outline determination is executed on the outline points after the step of performing thinning-out.

12. The image processing method according to claim 7, further comprising the step of performing smoothing that smoothes the outline points extracted by the step of performing outline point extraction according to positions of adjacent points of each outline point,
wherein the step of performing trimming outline determination is executed on the outline points after the step of performing smoothing.

13. The image processing method according to claim 1, wherein a selected image region is extracted from an original image by using a technique of extracting an attention-getting region in an image based on prescribed criteria.

14. The image processing method according to claim 1, wherein data related to an outer edge of a plurality of ovals or perfect circles, or a polygon, determined as the outline for trimming the image is stored as vector data in a storage unit.

15. An image processing apparatus comprising:
a distance conversion unit that calculates a distance value from a first pixel region on a trimming target side to a second pixel region on a background side of a binarized image;
a skeleton extraction unit that extracts a plurality of points indicating a skeleton of the first pixel region according to the distance value of each first pixel; and
a trimming outline determination unit that excludes a point, out of the plurality of extracted points, judged to be less significant based on prescribed conditions, draws an oval or a perfect circle according to the distance value of a pixel of each point, centered at a position of a non-excluded point, and determines outer edge of a plurality of drawn ovals or perfect circles as an outline for trimming an image on the trimming target side.

16. A program causing a computer to implement a process comprising:
processing of calculating a distance value from a first pixel region on a trimming target side to a second pixel region on a background side of a binarized image;
processing of extracting a plurality of points indicating a skeleton of the first pixel region according to the distance value of each first pixel; and
processing of excluding a point, out of the plurality of extracted points, judged to be less significant based on prescribed conditions, drawing an oval or a perfect circle according to the distance value of a pixel of each point, centered at a position of a non-excluded point, and determining an outer edge of a plurality of drawn ovals or perfect circles as an outline for trimming an image on the trimming target side.

17. An image processing system comprising:
a distance conversion unit that calculates a distance value from a first pixel region on a trimming target side to a second pixel region on a background side of a binarized image;
a skeleton extraction unit that extracts a plurality of points indicating a skeleton of the first pixel region according to the distance value of each first pixel;
a first trimming outline determination unit that excludes a point, out of the plurality of extracted points, judged to be less significant based on prescribed conditions, draws an oval or a perfect circle according to the distance value of a pixel of each point, centered at a position of a non-excluded point, and determines an outer edge of a plurality of drawn ovals or perfect circles as an outline for trimming an image on the trimming target side;
a maximum image extraction unit that extracts a maximum region in the first pixel region on the trimming target side of the binarized image;
an outline point extraction unit that extracts a plurality of outline points of the extracted maximum region in the first pixel region;
a second trimming outline determination unit that excludes an outline point, out of the plurality of extracted points, judged to be less significant based on prescribed conditions, and determines a polygon connecting adjacent points of non-excluded outline points as an outline for trimming the image on the trimming target side; and
a selection unit that selects one of a first outline determined by the first trimming outline determination unit and a second outline determined by the second trimming outline determination unit.

18. The image processing system according to claim 17, wherein the selection unit selects one of the first outline and the second outline according to any one of conditions including:
making random selection;
making selection based on a ratio of a total area of the first outline and a total area of the second outline;
making selection based on at least one shape of the first outline and the second outline; and
making selection based on an error of a shape of the first outline and a shape of the second outline with respect to the first pixel region after binarization.
